(19) United States
(12) Patent Application Publication
(10) Pub. No.: US 2010/0180286 A1
(43) Pub. Date: Jul. 15, 2010

(54) OPTICAL DISK DRIVE WITH A CONNECTING DEVICE

(76) Inventors: Jen-Chen Wu, Taoyuan County (TW); Yu-Sheng Wang, Taoyuan County (TW)

Correspondence Address: NORTH AMERICA INTELLECTUAL PROPERTY CORPORATION, P.O. BOX 506, MERRIFIELD, VA, 22116, US

(21) Appl. No.: 12/626,948

(22) Filed: Nov. 30, 2009

(30) Foreign Application Priority Data
Jan. 9, 2009 (TW) 098100884

(51) Int. Cl. G11B 17/04

(52) U.S. Cl. 720/606; G9B/17.013

(57) ABSTRACT

The invention provides an optical disk drive with a connecting device. The optical disk drive includes two guiding tracks disposed on two sides of a casing for holding a tray to slide in/out the casing, a circuit board disposed on the tray and electrically connected to a spindle motor and a pick-up head, a main board disposed inside the casing, a detecting switch disposed on the main board, and the connecting device. The connecting device includes a first part disposed on the main board, and a second part disposed on the circuit board for connecting with the first part. The first part is connected with the second part and the optical disk drive is powered on so as to transmit the electricity and the signals between the main board and the circuit board via the connecting device when the detecting switch detects the tray is positioned inside the casing.

### BACKGROUND OF THE INVENTION

1. Field of the Invention

The present invention relates to an optical disk drive, and more particularly, to an optical disk drive with a connecting device for transmitting electricity and signals.

2. Description of the Prior Art

A slim-typed optical disk drive utilizes a flexible cable electrically connected to a movable tray and a fixed main board for transmitting electricity and signals of electrical components of the tray. The reliability of the slim-typed optical disk drive needs to be maintained with stable transmission of the electricity and the signals in a long period of operation as the flexible cable moves with the tray smoothly.

As shown in FIG. 1, FIG. 1 is a sectional view of a conventional optical disk drive 10 disclosed in TW patent issued no. 568326. The optical disk drive 10 includes a hollow casing 11 for containing a main board 12 and a tray 13. The main board 12 is fixed inside the casing 11. An end of a flexible cable 14 is connected to the main board 12. A fixing portion 14a of the flexible cable 14 is disposed on a bottom of the casing 11, and a movable portion 14b of the flexible cable 14 is connected to a circuit board 15 disposed on a bottom of the tray 13 for transmitting the electricity and the signals of the electrical components of the tray 13. The electrical component can be a spindle motor 16, a pickup head 17, and so on. When the tray 13 is drawn out of the casing 11 for replacing an optical disk 18, the flexible cable 14 can eliminate static electricity from the user. When the tray 13 slides in the casing 11 for reading data on the optical disk 18, the spindle motor 16 rotates the optical disk 18, the pickup head 17 moves along radial direction of the optical disk 18 for reading data on the optical disk 18, and then the data on the optical disk 18 are transmitted to the main board 12 via the circuit board 15 and the flexible cable 14.

Because the tray 13 have to be drawn out of the casing 11 for replacing the optical disk 18 easily, the suspending movable portion 14b of the flexible cable 14 made of thin and soft plastic material is easily dropping. The over dropping movable portion 14b often touches or engages with an edge of the casing 11 easily, so that the flexible cable 14 is damaged when the tray 13 slides in the casing 11. A short-circuit fault of the flexible cable 14 might occur to affect the transmission of the electricity and the signals, or the flexible cable 14 hinders the tray 13 from sliding in/out the casing 11. In order to solve above-mentioned problems, a dropping part of the movable portion 14b can be coated with Mylar to form a supporting portion 14c in the prior art, so that strength of the flexible cable 14 is improved for holding the movable portion 14b and for preventing the movable portion 14b from dropping.

However, the flexible cable 14 drops down more easily, especially in a surrounding at high temperature with frequent operation, after adding a weight of the supporting portion 14c on the flexible cable 14 with poor elasticity. Besides, the flexible cable 14 is disposed between the tray 13 and the casing 11 in order to economize the size of the optical disk drive 10. The flexible cable 14 is wore and damaged easily when the flexible cable 14 moves in/out the casing 11 with the tray 13. The thickness of the optical disk drive 10 is limited to disposition of the flexible cable 14. Therefore, the transmission of the electricity and the signals of the tray in the conventional optical disk drive still has some problems to be solved.

### SUMMARY OF THE INVENTION

An objective of the present invention is to provide an optical disk drive with a connecting device for connecting a tray and a main board directly and for eliminating a flexible cable to economize the size of the optical disk drive.

Another objective of the present invention is to provide the optical disk drive with the connecting device for utilizing a detecting switch to detect whether the tray is connected to the main board, so that the optical disk drive is powered on after the detecting switch detects the tray is connected to the main board so as to prevent the connecting device from short circuit.

Another objective of the present invention is to provide the optical disk drive with the connecting device for utilizing an elastic pin to prevent the tray and the main board or an external interface from vibration.

In order to achieve the foregoing objectives of the invention, the optical disk drive includes two guiding tracks disposed on two sides of the casing for holding the tray to slide in/out the casing. A circuit board is disposed on the tray and electrically connected to a spindle motor and a pick-up head for transmitting electricity and signals. The main board is disposed inside the casing. The optical disk drive further includes a detecting switch disposed on the main board, and a connecting device including a first part disposed on the main board, and a second part disposed on the circuit board for connecting with the first part. The first part is connected to the second part when the tray is positioned inside the casing, and the optical disk drive is powered on so as to transmit the electricity and the signals between the main board and the circuit board via the connecting device when the detecting switch detects the tray is positioned inside the casing.

According to the claimed invention, the socket includes a body, a connecting cable, a pin, and an elastic component. A chamber is formed inside the body, and an opening is formed on the body and connected to the chamber. An end of the connecting cable is disposed on a bottom of the body, and the other end of the connecting cable passes through the body for connecting to the main board. A pin is inserted into the chamber of the body. An end of the elastic component is connected to the pin, and the other end of the elastic component is fixed on the body so as to slide the pin relative to the connecting cable and to keep electrical connection of the connecting cable and the pin, and there is a room between the tray and the main board or an external interface to prevent vibration.

Another objective of the present invention is to provide the optical disk drive including an external interface disposed on the casing. Two guiding tracks are disposed on two sides of the casing for holding the tray to slide in/out the casing. The optical disk drive further includes the detecting switch disposed on a rear end of the guiding tracks, and the circuit board disposed on the tray and electrically connected to the spindle motor and the pick-up head for transmitting the electricity and the signal. The main board is integrated with the circuit board. The optical disk drive further includes a connecting device including a first part disposed on the external interface, and a second part disposed on the circuit board for connecting with the first part. The first part is connected to the second part when the tray is positioned inside the casing, and the optical disk drive is powered on so as to transmit the electricity and the signals between the external interface and the circuit board via the connecting device when the detecting switch detects the tray is positioned inside the casing.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a sectional view of a conventional optical disk drive 10 in the prior art.

FIG. 2 is a diagram of an optical disk drive according to a first embodiment of the present invention.

FIG. 3 is an exploded diagram of the optical disk drive according to the first embodiment of the present invention.

FIG. 4 is a sectional view of the optical disk drive according to the first embodiment of the present invention.

FIG. 5 is a sectional view of a connecting device in a separating state according to the first embodiment of the present invention.

FIG. 6 is a sectional view of the connecting device in a combination state according to the first embodiment of the present invention.

FIG. 7 is a sectional view of an optical disk drive according to a second embodiment of the present invention.

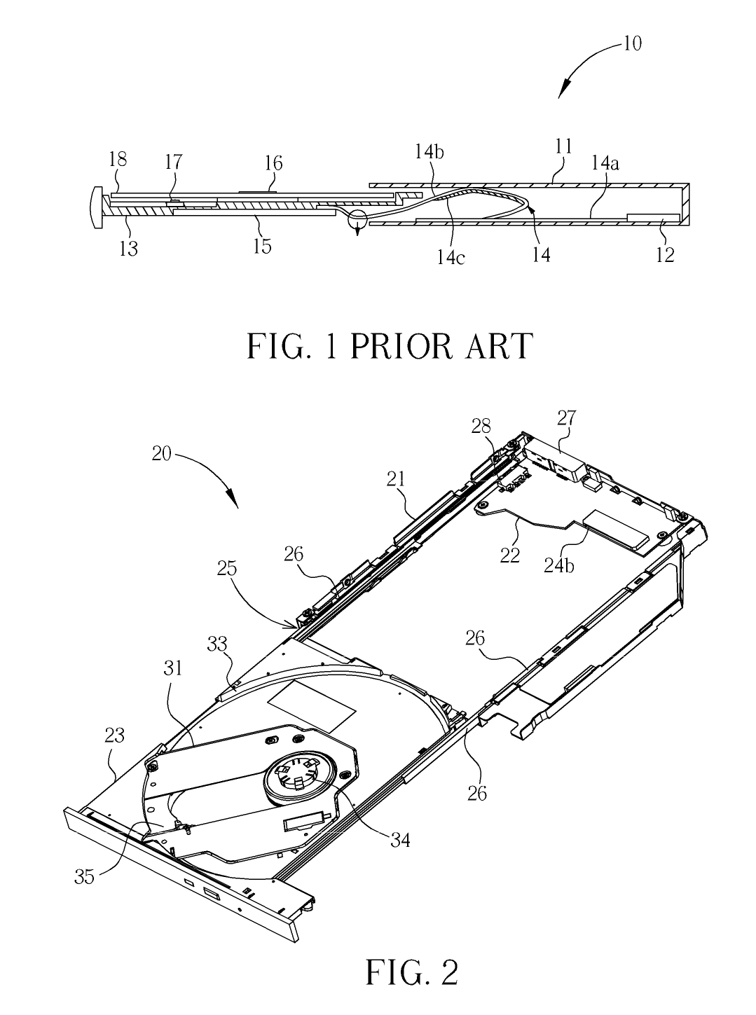

### DETAILED DESCRIPTION

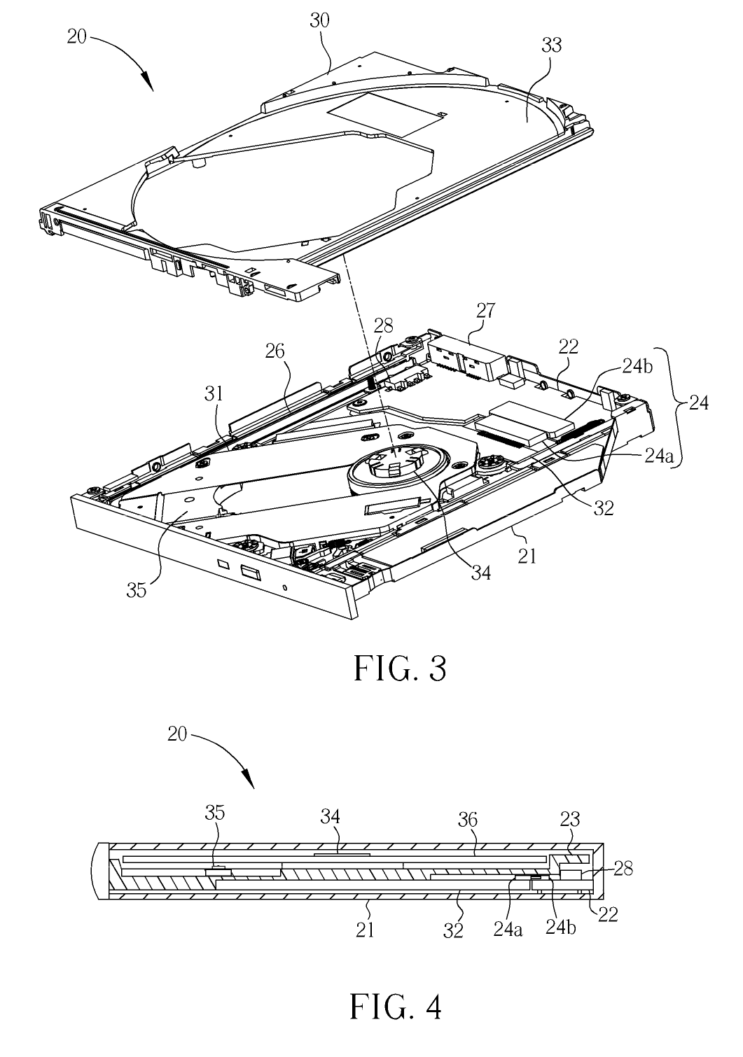

Please refer to FIG. 2 and FIG. 3. FIG. 2 is a diagram of an optical disk drive 20 according to a first embodiment of the present invention. FIG. 3 is an exploded diagram of the optical disk drive 20 according to the first embodiment of the present invention. The optical disk drive 20 can be a slim-typed optical disk drive. The optical disk drive 20 includes a casing 21, a main board 22, a tray 23, and a connecting device 24. A hollow space is formed inside the casing 21, and an opening 25 is formed on a front edge of the casing 21 and connected to the hollow space. Two guiding tracks 26 are disposed on two sides of the casing 21, respectively. The main board 22 is disposed on a rear end of the casing 21. An external interface 27 is disposed on a rear end of the main board 22 adjacent to the casing 21 for connecting to an external host. A detecting switch 28 is disposed on the main board 22 for detecting whether the tray 23 is positioned inside the casing 21 and for switching the optical disk drive 20. The detecting switch 28 can be a limit switch.

The tray 23 utilizes the guiding tracks 26 disposed on the two sides of the casing 21 to slide in/out the casing 21 through the opening 25. The tray 23 includes a main body 30, a traverse 31, and a circuit board 32. A recession 33 is formed on the main body 30 for holding an optical disk. The traverse 31 is disposed on a center of the recession 33, and a spindle motor 34 is disposed on the traverse 31 for rotating the optical disk. A pick-up head 35 is disposed on the traverse 31 for moving along a radial direction of the spindle motor 34 to read in/out data on the optical disk. The circuit board 32 is disposed under the traverse 31 and electrically connected to electronic components, such as the spindle motor 34 and the pick-up head 35, for transmitting electricity and signals.

The connecting device 24 can be a connector. The connecting device 24 includes a first part and a second part for connecting with the first part. The first part can be a plug 24a disposed on the main board 22, and the second part can be a socket 24b disposed on the circuit board 32. In this embodiment, the plug 24a is disposed on an edge of the main board 22 adjacent to a rear end of the casing 21, and the socket 24b is disposed on an edge of the circuit board 32 adjacent to a front end of the casing 21. However, positions of the plug 24a and the socket 24b are not limited to the above-mentioned embodiment and depend on design demand. For example, the plug 24a can further be disposed on the circuit board 32, and the socket 24b can further be disposed on the main board 22. When the plug 24a is connected with the socket 24b, the connecting device 24 transmits the electricity and the signals between the main board 22 and the circuit board 32.

Please refer to FIG. 4. FIG. 4 is a sectional view of the optical disk drive 20 according to the first embodiment of the present invention. When the tray 23 with the optical disk 36 does not slide in the casing 21, the plug 24a disposed on the rear edge of the circuit board 32 is separated from the socket 24b disposed on the front edge of the main board 22. The electronic components on the traverse, such as the spindle motor 34 and the pick-up head 35, can not receive the electricity via the connecting device 24. In addition, the detecting switch 28 does not detect the tray 23 is positioned inside the casing 21, so that electricity transmission of the optical disk drive 20 is cut, which means the socket 24b disposed on the main board 22 is also out of the electricity. On the other hand, when the tray 23 slides in the casing 21, the plug 24a disposed on the circuit board 32 moves into the casing 21 with the tray 23 and connects to the socket 24b disposed on the main board 22. In order to prevent the connecting device 24 from short circuit, the optical disk drive 20 is not powered on so as to keep non-electricity transmission between the plug 24a and the socket 24b when the detecting switch 28 detects the tray 23 just slides in the casing 21. When the plug 24a is completely connected to the socket 24b and a rear end of the tray 23 contacts the detecting switch 28, the detecting switch 28 detects the tray 23 is positioned inside the casing 21 and then power on the optical disk drive 20. Due to complete connection of the plug 24a and socket 24b, the electricity and the signals can be transmitted from the main board 22 to the circuit board 32 via the plug 24a and socket 24b of the connecting device 24. Therefore, the electronic components on the tray 23 can receive commands from the main board 22 so as to execute corresponding operations.

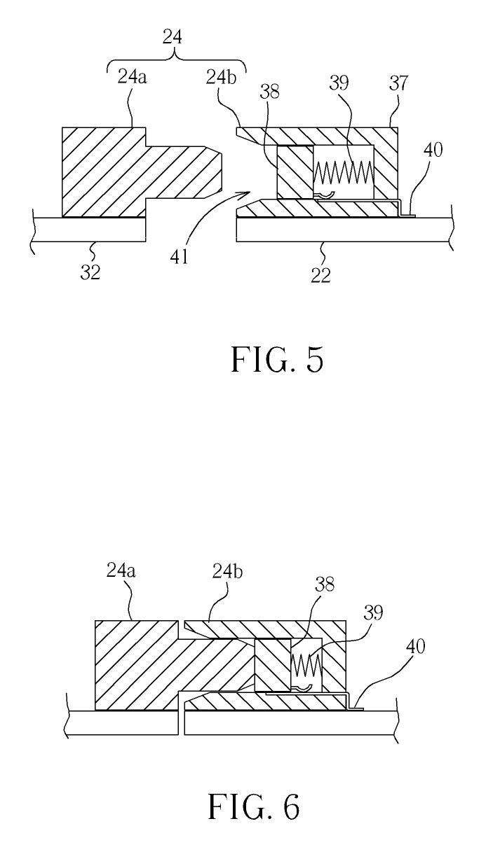

Please refer to FIG. 5. FIG. 5 is a sectional view of the connecting device 24 in a separating state according to the first embodiment of the present invention. For a stationary domestic optical disk drive, the tray 23 seldom moves relative to the main board 22 when operating, so that the plug 24a disposed on the circuit board 32 and the socket 24b disposed on the main board 22 are not damaged by vibration. On the other hand, for a portable optical disk drive, a space has to be reserved between the tray 23 and the main board 22 for preventing the connecting device 24 from being damaged by the vibration. Therefore, a shock-absorbing structure is disposed inside the socket 24b. The socket 24b can include a body 37, a pin 38, an elastic component 39, and a connecting cable 40. A chamber is formed inside the body 37, and an opening 41 is formed on the body 37 and connected to the chamber. An end of the connecting cable 40 is disposed on a bottom of the body 37, and the other end of the connecting cable 40 passes through the body 37 for connecting to the main board 22. The pin 38 is inserted into the chamber of the body 37 and contacts the connecting cable 40. An end of the elastic component 39 supports the pin 38, and the other end of the elastic component 39 is fixed on a lateral surface inside the body 37 so as to slide the pin 38 relative to the connecting cable 40 and to keep electrical connection of the connecting cable 40 and the pin 38. Please refer to FIG. 6. FIG. 6 is a sectional view of the connecting device 24 in a combination state according to the first embodiment of the present invention. When the plug 24a is inserted into the socket 24b, the pin 38 is pushed to compress the elastic component 39, and the electrical connection of the pin 38 and the connecting cable 40 is ensured.

Therefore, the connecting device 24 of the present invention can utilize the elastic component 39 to absorb the shock of the pin 38 so as to keep the electrical connection of the pin 38 and the connecting cable 40 for preventing disconnection of the electricity and the signals and for preventing the optical disk drive 20 from failing when the tray 23 is vibrated relative to the main board 22. Position of the elastic component 39 is not limited to the above-mentioned embodiment and depends on actual demand. For example, the elastic component 39 can be disposed on the plug 24a or outside the socket 24b.

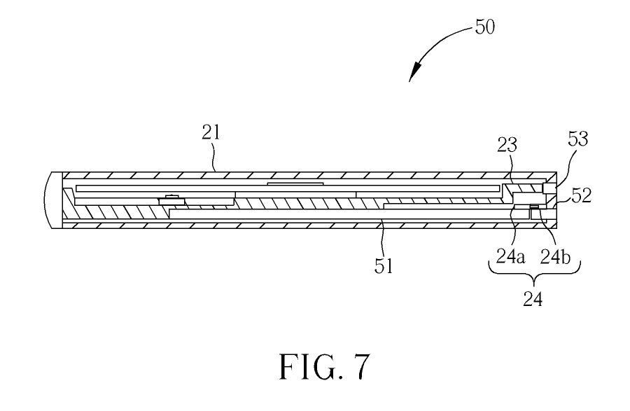

Please refer to FIG. 7. FIG. 7 is a sectional view of an optical disk drive 50 according to a second embodiment of the present invention. Structure of the optical disk drive 50 according to the second embodiment is similar with structure of the optical disk drive 20 according to the first embodiment, and elements of the second embodiment having the same numerals as ones of the first embodiment have the same structures and functions. Difference between the first embodiment and the second embodiment is the main board disposed on the rear end of the casing 21, which is integrated with a circuit board 51 of the tray 23. Therefore, the plug 24a and the socket 24b of the connecting device 24 are disposed on the circuit board 51 and an external interface 52, respectively. A detecting switch 53 is disposed on the rear end of the casing 21. When the tray 23 slides in the casing 21, the plug 24a disposed on a rear end of the circuit board 51 is connected to the socket 24b disposed on the external interface 52, the detecting switch 53 disposed on the casing 21 detects a contact from a rear end of the tray 23 and the powers on the optical disk drive 50 so as to transmit the electricity and the signals to the external host via the external interface 52.

Comparing to the prior art, the optical disk drive of the present invention can utilize the connecting device to transmit the electricity and the signals between the tray and the main board, so as to simplify the structure of the optical disk drive without utilizing the flexible cable. Without the flexible cable, the inner space of the optical disk drive can be reduced for achieving the purpose of downsizing. In addition, the optical disk drive with the connecting device of the present invention can utilize the detecting switch to detect whether the tray is positioned inside the casing so as to ensure a correct connection of the tray and the main board for preventing the connecting device from short circuit.

Those skilled in the art will readily observe that numerous modifications and alterations of the device and method may be made while retaining the teachings of the invention.

What is claimed is:

1. An optical disk drive comprising:
a casing, a hollow space being formed inside the casing, and two guiding tracks being disposed on two sides of the casing;
a tray whereon a circuit board is disposed, the circuit board being electrically connected to a spindle motor and a pick-up head for transmitting electricity and signals, and the guiding tracks holding the tray to slide in/out the casing;
a main board disposed inside the casing, a detecting switch being disposed on the main board; and
a connecting device comprising:
a first part disposed on the main board; and
a second part disposed on the circuit board for connecting with the first part;
wherein the first part is connected to the second part when the tray is positioned inside the casing, and the optical disk drive is powered on so as to transmit the electricity and the signals between the main board and the circuit board via the connecting device when the detecting switch detects the tray is positioned inside the casing.

2. The optical disk drive of claim 1, wherein the first part is a plug, and the second part is a socket for connecting with the plug.

3. The optical disk drive of claim 1, wherein the first part is a socket, and the second part is a plug for connecting with the socket.

4. The optical disk drive of claim 1, wherein the connecting device is a connector.

5. The optical disk drive of claim 2, wherein the socket comprises:
a body, a chamber being formed inside the body, and an opening being formed on the body and connected to the chamber; and
a connecting cable, an end of the connecting cable being disposed on a bottom of the body, and the other end of the connecting cable passing through the body for connecting to the main board.

6. The optical disk drive of claim 5, wherein the socket further comprises:
a pin inserted into the chamber of the body; and
an elastic component, an end of the elastic component being connected to the pin, and the other end of the elastic component being fixed on the body so as to slide the pin relative to the connecting cable and to keep electrical connection of the connecting cable and the pin.

7. The optical disk drive of claim 1, wherein an external interface is disposed on the main board adjacent to the casing for connecting to an external host.

8. The optical disk drive of claim 1, wherein the detecting switch is a limit switch.

9. The optical disk drive of claim 1, wherein the detecting switch detects the tray is positioned inside the casing when a rear end of the tray contacts the detecting switch.

10. The optical disk drive of claim 9, wherein the optical disk drive is powered on after the first part is connected to the second part and the detecting switch detects the tray is positioned inside the casing.

11. An optical disk drive comprising:
a casing, a hollow space being formed inside the casing, an external interface being disposed on the casing, two guiding tracks being disposed on two sides of the casing, and a detecting switch being disposed on a rear end of the guiding tracks;
a tray whereon a circuit board is disposed, the circuit board being electrically connected to a spindle motor and a pick-up head for transmitting electricity and signals, and the guiding tracks holding the tray to slide in/out the casing;
a connecting device comprising:
a first part disposed on the external interface; and
a second part disposed on the circuit board for connecting with the first part;
wherein the first part is connected to the second part when the tray is positioned inside the casing, and the optical disk drive is powered on so as to transmit the electricity and the signals between the external interface and the circuit board via the connecting device when the detecting switch detects the tray is positioned inside the casing.

12. The optical disk drive of claim 11, wherein the first part is a plug, and the second part is a socket for connecting with the plug.

13. The optical disk drive of claim 12, wherein the socket comprises:
a body, a chamber being formed inside the body, and an opening being formed on the body and connected to the chamber; and
a connecting cable, an end of the connecting cable being disposed on a bottom of the body, and the other end of the connecting cable passing through the body for connecting to the main board.

14. The optical disk drive of claim 13, wherein the socket further comprises:
a pin inserted into the chamber of the body; and
an elastic component, an end of the elastic component being connected to the pin, and the other end of the elastic component being fixed on the body so as to slide the pin relative to the connecting cable and to keep electrical connection of the connecting cable and the pin.

15. The optical disk drive of claim 11, wherein the detecting switch detects the tray is positioned inside the casing when a rear end of the tray contacts the detecting switch.

16. The optical disk drive of claim 15, wherein the optical disk drive is powered on after the first part is connected to the second part and the detecting switch detects the tray is positioned inside the casing.
